(19) United States
(12) Patent Application Publication
(10) Pub. No.: US 2024/0429788 A1
(43) Pub. Date: Dec. 26, 2024

(54) ELECTRIC MOTOR DRIVING DEVICE AND AIR CONDITIONER

(71) Applicant: Mitsubishi Electric Corporation, Tokyo (JP)

(72) Inventors: Akinori ISHIHARA, Tokyo (JP); Shinichiro URA, Tokyo (JP); Satoru ICHIKI, Tokyo (JP); Takeshi IIDA, Tokyo (JP)

(21) Appl. No.: 18/574,772

(22) PCT Filed: Nov. 26, 2021
(86) PCT No.: PCT/JP2021/043423

§ 371 Date: Dec. 28, 2023

(51) Int. Cl. H02K 11/33; F24F 11/88; H02K 11/27

(52) U.S. Cl. CPC H02K 11/33; F24F 11/88; H02K 11/27

(57) ABSTRACT

An electric motor driving device includes an inverter switching circuit of which a positive electrode side is connected to a positive electrode side of a smoothing capacitor and a negative electrode side is connected to a negative electrode side of the smoothing capacitor, a first wiring line that connects the positive electrode side of the smoothing capacitor and the positive electrode side of the inverter switching circuit, a second wiring line that connects the negative electrode side of the smoothing capacitor and the negative electrode side of the inverter switching circuit, a first snubber circuit that is connected to the first wiring line and the second wiring line, a current detector that detects a current flowing in a portion included in the second wiring line, and a capacitor that is connected to the negative electrode side of the smoothing capacitor and the negative electrode side of the inverter switching circuit.

### CROSS REFERENCE TO RELATED APPLICATION

This application is a U.S. national stage application of International Patent Application No. PCT/JP2021/043423 filed on Nov. 26, 2021, the disclosure of which is incorporated herein by reference.

### TECHNICAL FIELD

The present disclosure relates to an electric motor driving device including an inverter switching circuit, a snubber circuit, and a current detector, and to an air conditioner.

### BACKGROUND

Typically, an electric motor driving device including a snubber circuit that is connected to a switching unit of an inverter circuit in parallel has been known. For example, an inverter device that includes a circuit for rectifying and smoothing an AC power supply and a snubber circuit arranged between a smoothing capacitor and a switching element has been known (for example, refer to Patent Literature 1).

### PATENT LITERATURE

Patent Literature 1: Japanese Patent Application Laid-open No. H3-253265

However, a typical snubber circuit has a problem in that a switching noise that cannot be absorbed by a switching element flows into a current detector, noise components are superimposed, and it is not possible for the current detector to detect a current with high accuracy.

### SUMMARY

The present disclosure has been made in view of the above, and an object of the present disclosure is to obtain an electric motor driving device in which a current detector connected to a smoothing capacitor can accurately detect a current flowing in a portion connected to the smoothing capacitor.

To solve the problem and achieve the object described above, an electric motor driving device according to the present disclosure includes: a smoothing capacitor that smooths a DC voltage; a plurality of inverter switching circuits of which a positive electrode side is connected to a positive electrode side of the smoothing capacitor and a negative electrode side is connected to a negative electrode side of the smoothing capacitor; a first wiring line that connects the positive electrode side of the smoothing capacitor and the positive electrode side of each of the plurality of inverter switching circuits; and a second wiring line that connects the negative electrode side of the smoothing capacitor and the negative electrode side of each of the plurality of inverter switching circuits. The electric motor driving device according to the present disclosure further includes: a first snubber circuit that is connected to the first wiring line and the second wiring line; a current detector that detects a current flowing in a portion included in the first wiring line or the second wiring line connected to the positive electrode side or the negative electrode side of the smoothing capacitor; and a plurality of capacitors or a plurality of second snubber circuits that is connected to a side, connected to the current detector, that is one of the positive electrode side and the negative electrode side of the smoothing capacitor and to a side, connected to the current detector, that is one of the positive electrode side and the negative electrode side of each of the plurality of inverter switching circuits.

An electric motor driving device according to the present disclosure has an effect such that a current detector connected to a smoothing capacitor can accurately detect a current flowing in a portion connected to the smoothing capacitor.

### BRIEF DESCRIPTION OF DRAWINGS

FIG. 1 is a diagram illustrating a configuration of an electric motor driving device according to a first embodiment.

FIG. 2 is a diagram illustrating a configuration of an electric motor driving device according to a modification of the first embodiment.

FIG. 3 is a diagram illustrating a configuration of an electric motor driving device according to a second embodiment.

FIG. 4 is a diagram illustrating a configuration of an electric motor driving device according to a third embodiment.

FIG. 5 is a diagram illustrating a configuration of an electric motor driving device according to a modification of the third embodiment.

FIG. 6 is a diagram illustrating a configuration of an electric motor driving device according to a fourth embodiment.

FIG. 7 is a diagram illustrating a configuration of a second snubber circuit replaced with a capacitor included in the electric motor driving device according to the first to the fourth embodiments.

FIG. 8 is a diagram illustrating a processor in a case where an inverter control unit included in the electric motor driving device according to the second embodiment is implemented by the processor.

FIG. 9 is a diagram illustrating processing circuitry in a case where the inverter control unit included in the electric motor driving device according to the second embodiment is implemented by the processing circuit.

FIG. 10 is a diagram illustrating a configuration of an air conditioner according to a fifth embodiment.

### DETAILED DESCRIPTION

Hereinafter, an electric motor driving device and an air conditioner according to embodiments will be described in detail with reference to the drawings.

### First Embodiment

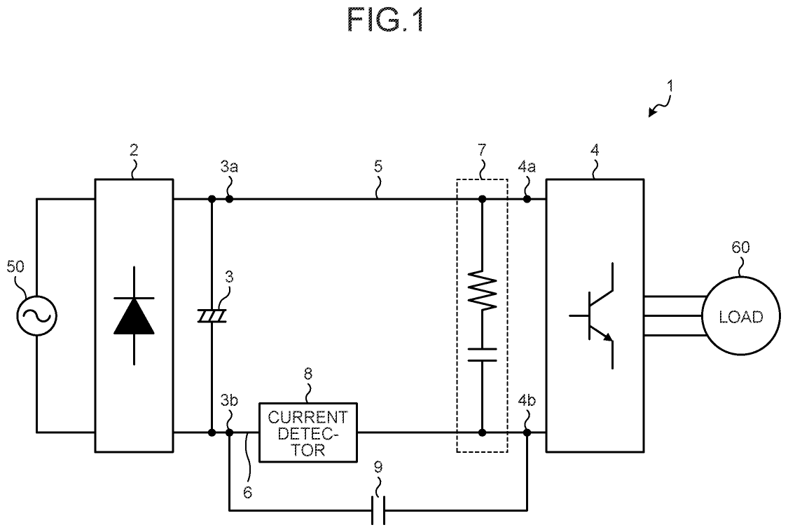

FIG. 1 is a diagram illustrating a configuration of an electric motor driving device 1 according to a first embodiment. The electric motor driving device 1 is a device, to which AC power is supplied from an AC power supply 50, that supplies the AC power to a load 60 and includes a rectifier circuit 2 that rectifies the AC power supplied from the AC power supply 50. In FIG. 1, the AC power supply 50 and the load 60 are illustrated.

The electric motor driving device 1 further includes a smoothing capacitor 3 that smooths a DC voltage obtained by the rectifier circuit 2 and an inverter switching circuit 4. The smoothing capacitor 3 supplies the smoothed DC power to the inverter switching circuit 4. The inverter switching circuit 4 includes, for example, an intelligent power module. A positive electrode side of the inverter switching circuit 4 is connected to a positive electrode side of the smoothing capacitor 3, a negative electrode side of the inverter switching circuit 4 is connected to a negative electrode side of the smoothing capacitor 3. The inverter switching circuit 4 converts the DC power supplied from the smoothing capacitor 3 into AC power and supplies the AC power obtained by conversion to the load 60.

The electric motor driving device 1 further includes a first wiring line 5 that connects the positive electrode side of the smoothing capacitor 3 and the positive electrode side of the inverter switching circuit 4 and a second wiring line 6 that connects the negative electrode side of the smoothing capacitor 3 and the negative electrode side of the inverter switching circuit 4. The first wiring line 5 may be referred to as a “P line 5”, and the second wiring line 6 may be referred to as an “N line 6”. The electric motor driving device 1 further includes a first snubber circuit 7 that is connected to the first wiring line 5 and the second wiring line 6. Each of the inverter switching circuit 4 and the first snubber circuit 7 is connected to the P line 5 and the N line 6. That is, the first snubber circuit 7 is arranged in parallel to the inverter switching circuit 4.

The electric motor driving device 1 further includes a current detector 8 that detects a current flowing in a portion 3b included in the second wiring line 6 connected to the negative electrode side of the smoothing capacitor 3. The current detector 8 detects a current flowing in the N line 6. The electric motor driving device 1 further includes a capacitor 9 that is connected to the negative electrode side of the smoothing capacitor 3 and the negative electrode side of the inverter switching circuit 4. The capacitor 9 is connected to the portion 3b and a portion 4b included in the N line 6. The capacitor 9 is, for example, a ceramic capacitor.

With the above configuration, the electric motor driving device 1 according to the first embodiment can suppress an inflow of a high-frequency component into the current detector 8 by bypassing the high-frequency component caused by a surge or the like generated by switching of the inverter switching circuit 4 with the capacitor 9. More specifically, the electric motor driving device 1 suppresses the high-frequency component caused by the surge or the like generated by the switching of the inverter switching circuit 4 or the like with the first snubber circuit 7. However, by bypassing a high-frequency component that cannot be suppressed with the capacitor 9, it is possible to suppress the inflow of the high-frequency component into the current detector 8. Therefore, in the electric motor driving device 1, the current detector 8 connected to the smoothing capacitor 3 can accurately detect the current flowing in the portion 3b connected to the smoothing capacitor 3.

Since the electric motor driving device 1 according to the first embodiment can use the relatively small capacitor 9, restriction in an installation place of the capacitor 9 is small, and the first snubber circuit 7 can be downsized because the capacitor 9 can suppress the high-frequency component.

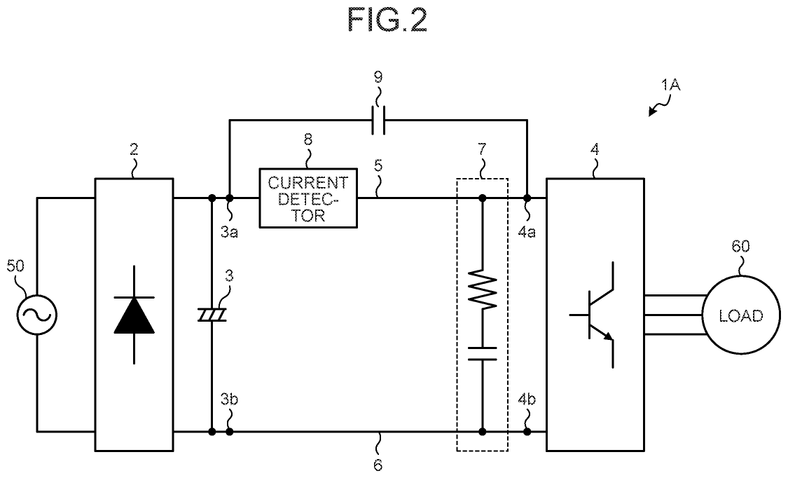

FIG. 2 is a diagram illustrating a configuration of an electric motor driving device 1A according to a modification of the first embodiment. The electric motor driving device 1A includes all the components of the electric motor driving device 1. The electric motor driving devices 1A and 1 are different from each other in that positions where the current detector 8 and the capacitor 9 are disposed are different.

In the electric motor driving device 1A, the current detector 8 detects a current flowing in a portion 3a included in the first wiring line 5 connected to the positive electrode side of the smoothing capacitor 3. The current detector 8 detects a current flowing in the P line 5. The capacitor 9 is connected to the positive electrode side of the smoothing capacitor 3 and the positive electrode side of the inverter switching circuit 4. The capacitor 9 is connected to the portion 3a and a portion 4a included in the P line 5.

### Second Embodiment

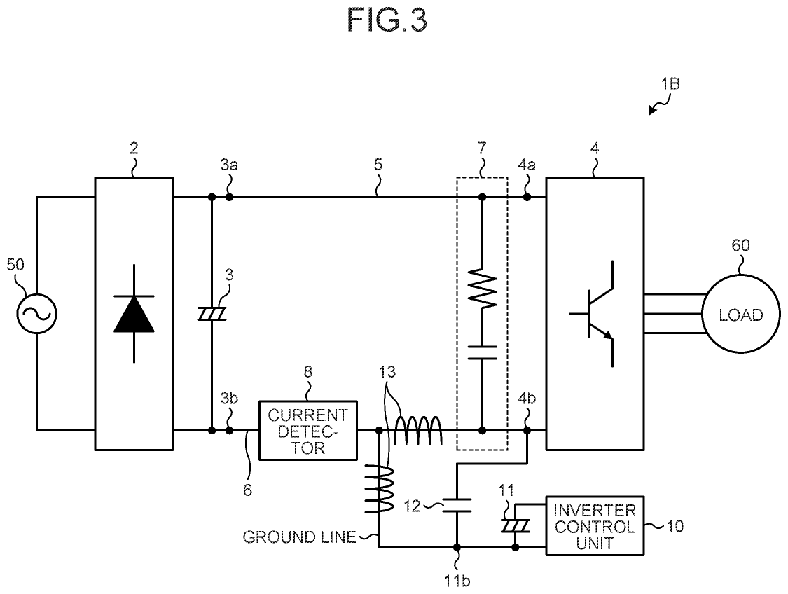

FIG. 3 is a diagram illustrating a configuration of an electric motor driving device 1B according to a second embodiment. The electric motor driving device 1B includes the rectifier circuit 2, the smoothing capacitor 3, the inverter switching circuit 4, the first wiring line 5, the second wiring line 6, the first snubber circuit 7, and the current detector 8 included in the electric motor driving device 1 according to the first embodiment. In the second embodiment, differences from the first embodiment will be mainly described.

The electric motor driving device 1B further includes an inverter control unit 10 that is connected to the ground and controls the inverter switching circuit 4, an inverter control power supply 11 that is a power supply of the inverter control unit 10, and a capacitor 12 that is connected to a negative electrode side of the inverter switching circuit 4 and the ground. The capacitor 12 is connected to the portion 4b included in an N line 6 and a portion 11b on a ground side of the inverter control power supply 11. The capacitor 12 is, for example, a ceramic capacitor.

In the electric motor driving device 1B according to the second embodiment, since the current detector 8 and the inverter switching circuit 4 are relatively separated from each other, wiring inductances 13 caused by restriction in an installation place of the current detector 8 are generated between the current detector 8 and the inverter switching circuit 4 and between the current detector 8 and the inverter control unit 10. However, with the configuration of the electric motor driving device 1B, it is possible to absorb a high-frequency component caused by a surge or the like generated by switching of the inverter switching circuit 4 or the like by the capacitor 12 and to suppress an effect caused by the wiring inductance 13. As a result, the electric motor driving device 1B can suppress the inflow of the high-frequency component into the current detector 8. Therefore, in the electric motor driving device 1B, the current detector 8 connected to the smoothing capacitor 3 can accurately detect a current flowing in the portion 3b connected to the smoothing capacitor 3.

### Third Embodiment

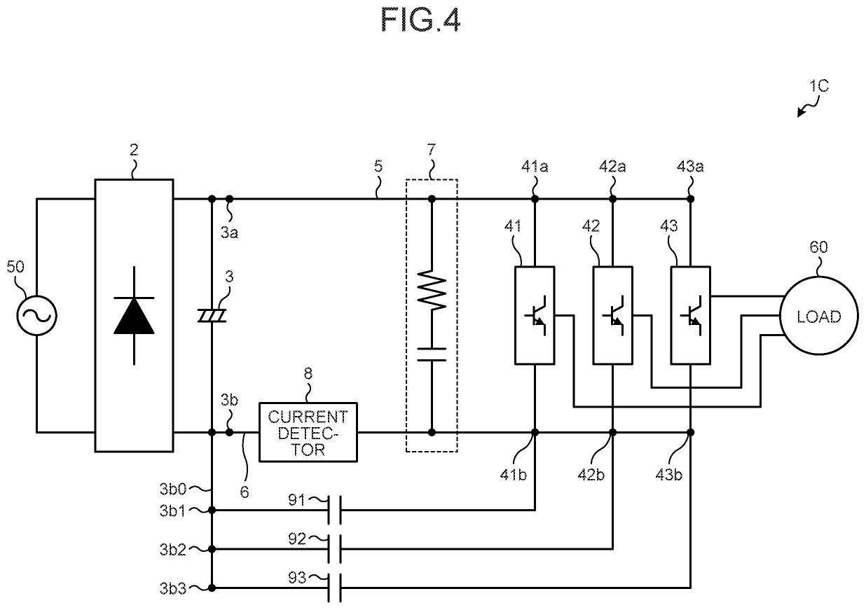

FIG. 4 is a diagram illustrating a configuration of an electric motor driving device 1C according to a third embodiment. The electric motor driving device 1C includes the rectifier circuit 2, the smoothing capacitor 3, the first wiring line 5, the second wiring line 6, the first snubber circuit 7, and the current detector 8 included in the electric motor driving device 1 according to the first embodiment. In the third embodiment, differences from the first embodiment will be mainly described.

The electric motor driving device 1C includes a first inverter switching circuit 41, a second inverter switching circuit 42, and a third inverter switching circuit 43, instead of the inverter switching circuit 4 included in the electric motor driving device 1. Each of the first inverter switching circuit 41, the second inverter switching circuit 42, and the third inverter switching circuit 43 is an inverter switching circuit having a positive electrode side connected to a positive electrode side of the smoothing capacitor 3. The first inverter switching circuit 41, the second inverter switching circuit 42, and the third inverter switching circuit 43 are an example of a plurality of inverter switching circuits.

The first wiring line 5 according to the third embodiment connects the positive electrode side of the smoothing capacitor 3 and the positive electrode side of each of the first inverter switching circuit 41, the second inverter switching circuit 42, and the third inverter switching circuit 43. The second wiring line 6 according to the third embodiment connects a negative electrode side of the smoothing capacitor 3 and a negative electrode side of each of the first inverter switching circuit 41, the second inverter switching circuit 42, and the third inverter switching circuit 43.

The electric motor driving device 1C includes a first capacitor 91, a second capacitor 92, and a third capacitor 93, instead of the capacitor 9 included in the electric motor driving device 1. The first capacitor 91, the second capacitor 92, and the third capacitor 93 are an example of a plurality of capacitors. Each of the first capacitor 91, the second capacitor 92, and the third capacitor 93 is, for example, a ceramic capacitor. Each of the first capacitor 91, the second capacitor 92, and the third capacitor 93 is connected to the negative electrode side of the smoothing capacitor 3 and the negative electrode side of each of the first inverter switching circuit 41, the second inverter switching circuit 42, and the third inverter switching circuit 43.

The first capacitor 91 is connected to a portion 3b1 included in a wiring line 3b0 connected to the portion 3b included in the N line 6 and a portion 41b included in the N line 6. The negative electrode side of the first inverter switching circuit 41 is connected to the portion 41b. The second capacitor 92 is connected to a portion 3b2 included in the wiring line 3b0 and a portion 42b included in the N line 6. The negative electrode side of the second inverter switching circuit 42 is connected to the portion 42b. The third capacitor 93 is connected to a portion 3b3 included in the wiring line 3b0 and a portion 43b included in the N line 6. The negative electrode side of the third inverter switching circuit 43 is connected to the portion 43b.

A case is assumed where the first inverter switching circuit 41 be connected to a U-phase of a load 60, the second inverter switching circuit 42 be connected to a V-shape of the load 60, and the third inverter switching circuit 43 be connected to a W-phase of the load 60. In this case, by bypassing a high-frequency component caused by the surge or the like generated by the switching of each of the first inverter switching circuit 41, the second inverter switching circuit 42, and the third inverter switching circuit 43 or the like with the first capacitor 91, the second capacitor 92, and the third capacitor 93 connected to the respective phases, the electric motor driving device 1C according to the third embodiment can suppress the inflow of the high-frequency component into the current detector 8.

In addition, in the electric motor driving device 1C, the high-frequency component caused by the surge or the like generated by the switching of the first inverter switching circuit 41, the second inverter switching circuit 42, and the third inverter switching circuit 43 or the like is suppressed by the first snubber circuit 7. However, the high-frequency component that cannot be suppressed is bypassed by the first capacitor 91, the second capacitor 92, and the third capacitor 93, and accordingly, it is possible to suppress the inflow of the high-frequency component into the current detector 8. Therefore, in the electric motor driving device 1C, the current detector 8 connected to the smoothing capacitor 3 can accurately detect a current flowing in the portion 3b connected to the smoothing capacitor 3.

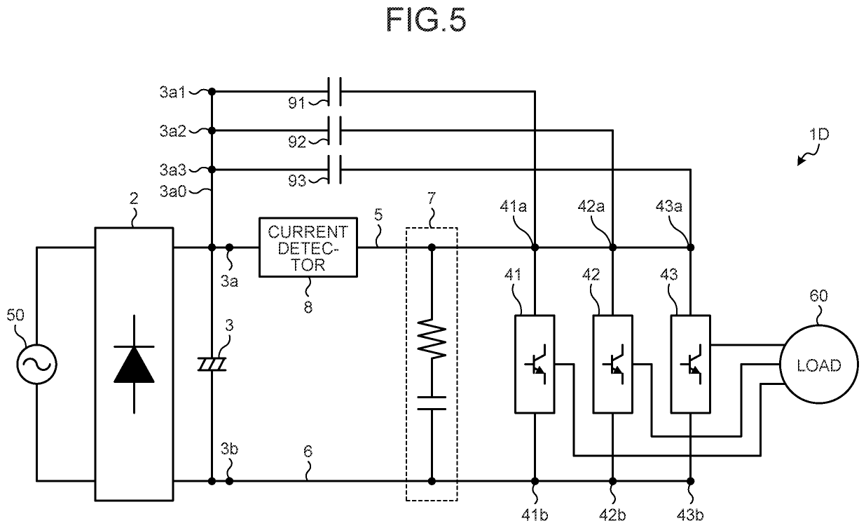

FIG. 5 is a diagram illustrating a configuration of an electric motor driving device 1D according to a modification of the third embodiment. The electric motor driving device 1D includes all the components of the electric motor driving device 1C, other than the wiring line 3b0. The electric motor driving device 1D and the electric motor driving device 1C are different from each other in that positions where the current detector 8, the first capacitor 91, the second capacitor 92, and the third capacitor 93 are disposed are different.

In the electric motor driving device 1D, the current detector 8 detects a current flowing in the portion 3a included in the first wiring line 5 connected to the positive electrode side of the smoothing capacitor 3. The current detector 8 detects a current flowing in the P line 5. The first capacitor 91 is connected to a portion 3a1 included in a wiring line 3a0 connected to the portion 3a included in the P line 5 and a portion 41a included in the P line 5. The positive electrode side of the first inverter switching circuit 41 is connected to the portion 41a. The second capacitor 92 is connected to a portion 3a2 included in the wiring line 3a0 and a portion 42a included in the P line 5. The positive electrode side of the second inverter switching circuit 42 is connected to the portion 42a. The third capacitor 93 is connected to a portion 3a3 included in the wiring line 3a0 and a portion 43a included in the P line 5. The positive electrode side of the third inverter switching circuit 43 is connected to the portion 43a.

### Fourth Embodiment

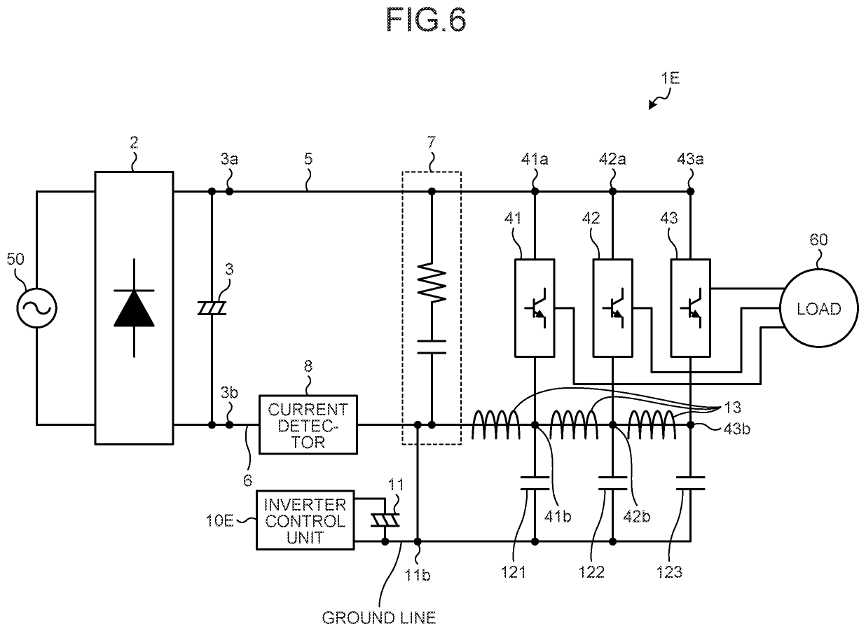

FIG. 6 is a diagram illustrating a configuration of an electric motor driving device 1E according to a fourth embodiment. The electric motor driving device 1E includes the rectifier circuit 2, the smoothing capacitor 3, the first inverter switching circuit 41, the second inverter switching circuit 42, the third inverter switching circuit 43, the first wiring line 5, the second wiring line 6, the first snubber circuit 7, and the current detector 8 included in the electric motor driving device 1C according to the third embodiment. In the fourth embodiment, differences from the third embodiment will be mainly described.

The electric motor driving device 1E further includes an inverter control unit 10E that is connected to the ground and controls the first inverter switching circuit 41, the second inverter switching circuit 42, and the third inverter switching circuit 43 and the inverter control power supply 11 that is a power supply of the inverter control unit 10E.

The electric motor driving device 1E further includes a fourth capacitor 121 that is connected to a negative electrode side of the first inverter switching circuit 41 and the ground, a fifth capacitor 122 that is connected to a negative electrode side of the second inverter switching circuit 42 and the ground, and a sixth capacitor 123 that is connected to a negative electrode side of the third inverter switching circuit 43 and the ground. The fourth capacitor 121, the fifth capacitor 122, and the sixth capacitor 123 are an example of a plurality of capacitors. Each of the fourth capacitor 121, the fifth capacitor 122, and the sixth capacitor 123 is, for example, a ceramic capacitor.

The fourth capacitor 121 is connected to the portion 41b included in the N line 6 and the portion 11b on the ground side of the inverter control power supply 11. The fifth capacitor 122 is connected to the portion 42b included in the N line 6 and the portion 11b on the ground side of the inverter control power supply 11. The sixth capacitor 123 is connected to the portion 43b included in the N line 6 and the portion 11b on the ground side of the inverter control power supply 11.

A case is assumed where the first inverter switching circuit 41 be connected to a U-phase of a load 60, the second inverter switching circuit 42 be connected to a V-shape of the load 60, and the third inverter switching circuit 43 be connected to a W-phase of the load 60. In this case, the electric motor driving device 1E according to the fourth embodiment absorbs effects caused by a wiring inductance 13 with the fourth capacitor 121, the fifth capacitor 122, and the sixth capacitor 123 respectively connected to the U-phase, the V-phase, and the W-phase of the load 60, for the high-frequency component caused by the surge or the like generated by switching of each of the first inverter switching circuit 41, the second inverter switching circuit 42, and the third inverter switching circuit 43 or the like. As a result, the electric motor driving device 1E can suppress the inflow of the high-frequency component into the current detector 8. Therefore, in the electric motor driving device 1E, the current detector 8 connected to the smoothing capacitor 3 can accurately detect the current flowing in the portion 3b connected to the smoothing capacitor 3.

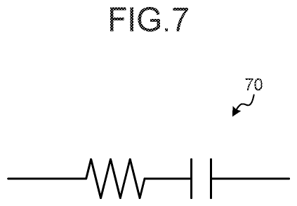

Note that, each of the capacitor 9, the capacitor 12, the first capacitor 91, the second capacitor 92, the third capacitor 93, the fourth capacitor 121, the fifth capacitor 122, and the sixth capacitor 123 included in the electric motor driving devices 1, 1A, 1B, 1C, 1D, and 1E according to the first to fourth embodiments may be replaced with a second snubber circuit 70 illustrated in FIG. 7. FIG. 7 is a diagram illustrating a configuration of the second snubber circuit 70 replaced with each of the capacitor 9, the capacitor 12, the first capacitor 91, the second capacitor 92, the third capacitor 93, the fourth capacitor 121, the fifth capacitor 122, and the sixth capacitor 123 included in the electric motor driving devices 1, 1A, 1B, 1C, 1D, and 1E according to the first to fourth embodiments.

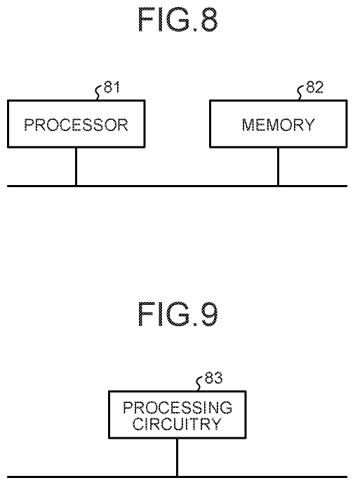

FIG. 8 is a diagram illustrating a processor 81 in a case where the inverter control unit 10 included in the electric motor driving device 1B according to the second embodiment is implemented by the processor 81. That is, functions of the inverter control unit 10 may be implemented by the processor 81 for executing a program stored in a memory 82. The processor 81 is a central processing unit (CPU), a processing device, an arithmetic device, a microprocessor, or a digital signal processor (DSP). In FIG. 8, the memory 82 is also illustrated.

In a case where the functions of the inverter control unit 10 are implemented by the processor 81, the functions are implemented by the processor 81 and software, firmware, or a combination of the software and the firmware. The software or the firmware is written as a program and stored in the memory 82. The processor 81 implements the functions of the inverter control unit 10 by reading and executing the program stored in the memory 82.

In a case where the functions of the inverter control unit 10 are implemented by the processor 81, the electric motor driving device 1B includes the memory 82 that stores a program for executing a step to be executed by the inverter control unit 10 as a result. It can be said that the program stored in the memory 82 causes a computer to execute the functions of the inverter control unit 10.

The memory 82 is, for example, a nonvolatile or a volatile semiconductor memory such as a random access memory (RAM), a read only memory (ROM), a flash memory, an erasable programmable read only memory (EPROM), or an electrically erasable programmable read-only memory (EEPROM, registered trademark); a magnetic disk; a flexible disk; an optical disk; a compact disk; a mini disk; a digital versatile disc (DVD), or the like.

FIG. 9 is a diagram illustrating processing circuitry 83 in a case where the inverter control unit 10 included in the electric motor driving device 1B according to the second embodiment is implemented by the processing circuitry 83. That is, the inverter control unit 10 may be implemented by the processing circuitry 83. The processing circuitry 83 is dedicated hardware. The processing circuitry 83 corresponds to, for example, a single circuit, a composite circuit, a programmed processor, a parallel-programmed processor, an application specific integrated circuit (ASIC), a field-programmable gate array (FPGA), or a combination thereof.

A part of the plurality of functions of the inverter control unit 10 may be implemented by software or firmware, and the rest of the plurality of functions may be implemented by dedicated hardware. In this way, the plurality of functions of the inverter control unit 10 can be implemented by hardware, software, firmware, or a combination thereof.

The inverter control unit 10E included in the electric motor driving device 1E according to the fourth embodiment may be implemented by a processor for executing a program stored in a memory. The memory is a memory similar to the memory 82. The processor is a processor similar to the processor 81. The inverter control unit 10E may be implemented by processing circuitry. The processing circuit is a processing circuit similar to the processing circuitry 83.

### Fifth Embodiment

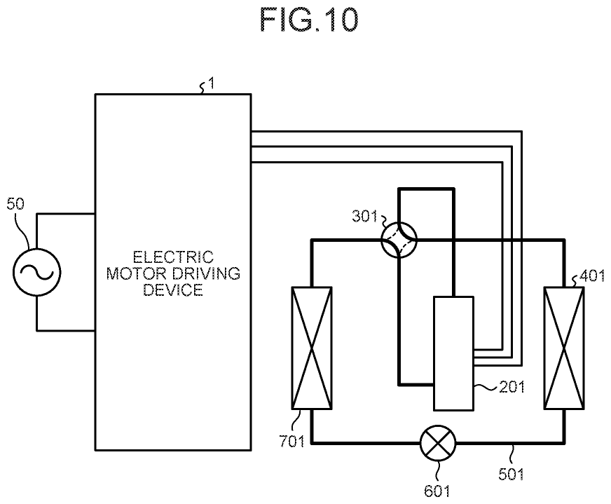

FIG. 10 is a diagram illustrating a configuration of an air conditioner according to a fifth embodiment. The air conditioner includes the electric motor driving device 1 according to the first embodiment, an AC power supply 50, a compressor 201, a four-way valve 301, an outdoor heat exchanger 401, a refrigerant pipe 501, an expansion valve 601, an indoor heat exchanger 701. The electric motor driving device 1 may be replaced with the electric motor driving device 1A according to the modification of the first embodiment, the electric motor driving device 1B according to the second embodiment, the electric motor driving device 1C according to the third embodiment, the electric motor driving device 1D according to the modification of the third embodiment, or the electric motor driving device 1E according to the fourth embodiment.

The configurations indicated in the above embodiments indicate examples and can be combined with other known techniques. Furthermore, the embodiments can be combined with each other, and some configurations can be partially omitted or changed without departing from the gist.

1-2. (canceled)

3. An electric motor driving device comprising:
a smoothing capacitor to smooth a DC voltage;
a plurality of inverter switching circuits of which a positive electrode side is connected to a positive electrode side of the smoothing capacitor and a negative electrode side is connected to a negative electrode side of the smoothing capacitor;
a first wiring line to connect the positive electrode side of the smoothing capacitor and the positive electrode side of each of the plurality of inverter switching circuits;
a second wiring line to connect the negative electrode side of the smoothing capacitor and the negative electrode side of each of the plurality of inverter switching circuits;
a first snubber circuit connected to the first wiring line and the second wiring line;
a current detector to detect a current flowing in a portion included in the first wiring line or the second wiring line connected to the positive electrode side or the negative electrode side of the smoothing capacitor; and
a plurality of capacitors or a plurality of second snubber circuits connected to a side, connected to the current detector, that is one of the positive electrode side and the negative electrode side of the smoothing capacitor and to a side, connected to the current detector, that is one of the positive electrode side and the negative electrode side of each of the plurality of inverter switching circuits.

4. (canceled)

5. An air conditioner comprising:
the electric motor driving device according to claim 3;
a compressor;
a four-way valve;
an outdoor heat exchanger;
a refrigerant pipe;
an expansion valve; and
an indoor heat exchanger.
